(19) United States
(12) Patent Application Publication
(10) Pub. No.: US 2026/0046753 A1
(43) Pub. Date: Feb. 12, 2026

(54) LINKING UPLINK RESPONSES TO DOWNLINK TRIGGERS

(71) Applicant: INTERDIGITAL PATENT HOLDINGS, INC., Wilmington, DE (US)

(72) Inventors: Mohamad Kenan Al-Hares, Canterbury (GB); Michael Starsinic, Newtown, PA (US); Guanzhou Wang, Brossard (CA); Samir Ferdi, Kirkland (CA); Alec Brusilovsky, Downingtown, PA (US); Anuj Sethi, Ottawa (CA)

(73) Assignee: INTERDIGITAL PATENT HOLDINGS, INC., Wilmington, DE (US)

(21) Appl. No.: 18/798,403

(22) Filed: Aug. 8, 2024

(51) Int. Cl. H04W 48/16; H04L 1/1607

(52) U.S. Cl. CPC H04W 48/16; H04L 1/1614

(57) ABSTRACT

A system and method for linking uplink responses to downlink triggers are described. The system and method may enable the network to associate the network or request in the downlink with the ambient-power enabled IoT (AIoT) device(s) response in the uplink. The response identification entity (RIE) sends a request identifier alongside the initiated AIoT triggering request by a network network function (NF), such as the application function (AF), to the AIoT device. When an AIoT device receives the request, the AIoT device analyses the response message and sends a response message to the network. When the RIE receives the response message from the access and mobility management function (AMF), the RIE analyses the response message and associates the response with the request. The RIE sends the IDs of the NFs that have initiated the request to the AMF. The AMF uses the NF IDs to route the response.

### BACKGROUND

An AIoT service, which might be located in the AF, may send a request or a trigger to one or more ambient IoT devices to obtain certain information or trigger certain actions in these devices. Such ambient IoT devices may be reachable through a different number of relay devices or different routes. These relay devices may store or forward the request to the AIoT device based on the AIoT device state or current condition. For example, the relay devices may store the request if the AIoT has limited power available or in disconnect state. The AIoT device inventory response may be sent through different relay devices or routes to reach its destination. The variations in the request and response routes and number of relay devices that may be used to reach the AIoT device, in the downlink, and network, in the uplink, can lead to variability in the response delay between AIoT devices. The response delays can make associating each network request in the downlink with the AIoT device response in the uplink challenging for the network.

When a network node, which has no context stored for an ambient IoT device, receives a message from the AIoT device, there is no mechanism in the existing system for the network node to associate the uplink message with a downlink request. Associating the uplink message with a downlink request is helpful in determine what AF to send the uplink message to and it is helpful in assisting the AF to determining how to process the information in the uplink message. Given that a first network node may cause a downlink trigger message to be broadcasted, the trigger message may cause the AIoT device to transmit an uplink response message to the network, and a second network node may receive the uplink response message, it is desirable to provide a solution for the second network node to associate the uplink message with a downlink trigger. In other words, the network node that sends the trigger and the network node that receives the response may be different.

### SUMMARY

A system and method for linking uplink responses to downlink triggers are described. The system and method may enable the network to associate the network or request in the downlink with the ambient-power enabled IoT (AIoT) device(s) response in the uplink. The response identification entity (RIE) sends a request identifier alongside the initiated AIoT triggering request by a network network function (NF), such as the application function (AF), to the AIoT device. When an AIoT device receives the request, the AIoT device analyses the response message. The AIoT device sends a response message to the network. The response message may have a response identifier and requested information. When the RIE receives the response message from the access and mobility management function (AMF), the RIE analyses the response message and associates the response with the request using the response identifier value. The RIE sends the IDs of the NFs that have initiated the request to the AMF. The AMF uses the NF IDs to route the response.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates is a reference model of a potential architecture of 5G or NextGen network;

FIG. 3 illustrates an example signaling diagram depicting the network associating an AIoT devices response to the corresponding service or network request;

FIG. 4 illustrates a method 500 performed in an RIE; and

FIG. 5 illustrates a method 600 performed in an AIoT.

### DETAILED DESCRIPTION

The present system, device and method provides a network function, response identification entity (RIE), to assist other network functions in associating a response with a request. When the network sends a request to the AIoT device, the network adds a request identifier to the request. The request identifier may be produced by certain functionality in the network, such as the RIE. The RIE may be a network function or a network service. When an AIoT device responds to a network request, the AIoT device may produce the response identifier. The response identifier is generated using known values and methods for both the WTRU and the network. The WTRU may be preconfigured with key values that contribute to the response identifier production or contribute to the values that can be part of the response identifier. When the network receives the response identifier, it maps the response identifier to the request identifier by extracting it. Extracting the request identifier from the response identifier may be performed using the WTRU-ID and request identifier. Extracting the request identifier from the response identifier may be performed using the preconfigured key values which can be utilized to generate values that can be used in extracting the request identifier from the response identifier by applying certain mutually agreed, between ambient IoT device and network, operations or algorithms, such as logical XOR operation, for example. After performing the mapping between the request and response identifiers, the RIE may send the ID(s) of the NF(s) or destination which the AMF may route the response to such as NEF-ID and AF-ID.

A method performed in a network node is described. The method includes receiving a request to trigger creation of a request identifier, the request received from a network entity, wherein the request for a message identifier includes a sequence number and at least one of an network function (NF) identifier or an application function (AF) identifier, calculating a request identifier and storing context information associated with the request identifier, sending a first response including the request identifier, receiving a second request including a response identifier, determining that the response identifier of the received second request is associated with the request identifier, and sending a response, wherein the response includes the sequence number and the at least one of the NF identifier or the AF identifier. The network node may be a response identification entity. The NF identifier may be an NEF identifier. The request identifier may include a routing indicator. The context information may include the at least one of an NF identifier or an AF identifier and the sequence number. The first identifier response may include a key set identifier. The second request may include the identity of an AIoT device. The second request may include information about a location from where the response identifier was received. The second request may include an identity of an ambient-power enabled internet of things (AIoT) device and information about a location from where the response identifier was received.

A method performed in a wireless transmit receive unit (WTRU) is described. The method includes receiving a configuration information, receiving a triggering request including a target identifier and a request identifier, determining whether to respond to the received request based on determining that the target identifier identifies the WTRU or identifies a group of WTRUs that the WTRU is associated with, determining a response identifier, and sending a response message, wherein the response message includes the response identifier. The WTRU may be an AIoT device. The configuration information may be pre-configured in a USIM. The configuration information may be pre-configured in memory of the WTRU. The configuration information may be sent to the WTRU by a network node. The network node may be an AMF. The configuration information may include credentials used to generate a response identifier. The configuration information may include keys and values to generate a response identifier and wherein the keys are associated with a KSI value. The target identifier may identify the WTRU. The response identifier may be determined based on the request identifier and at least one value that was configured in the WTRU. A response message may be sent to a network node.

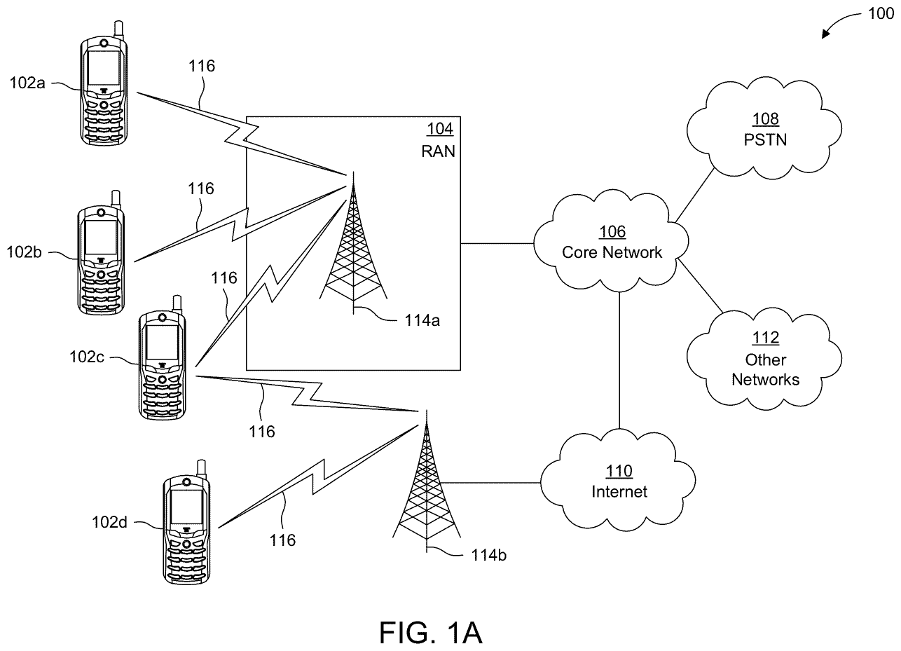

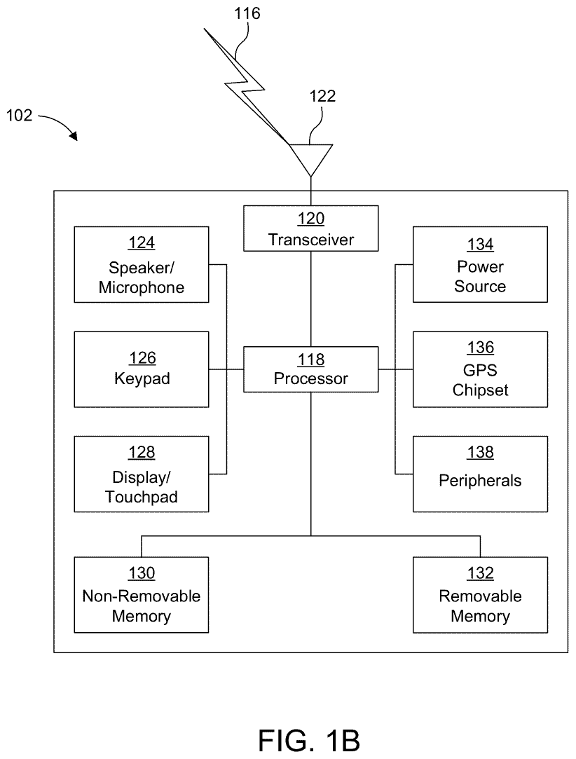

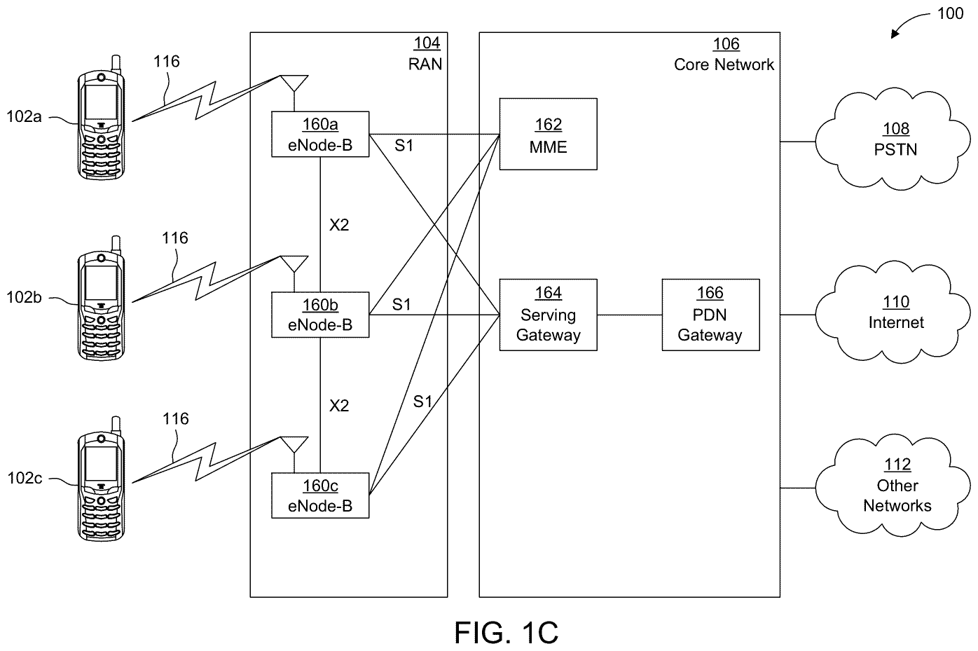

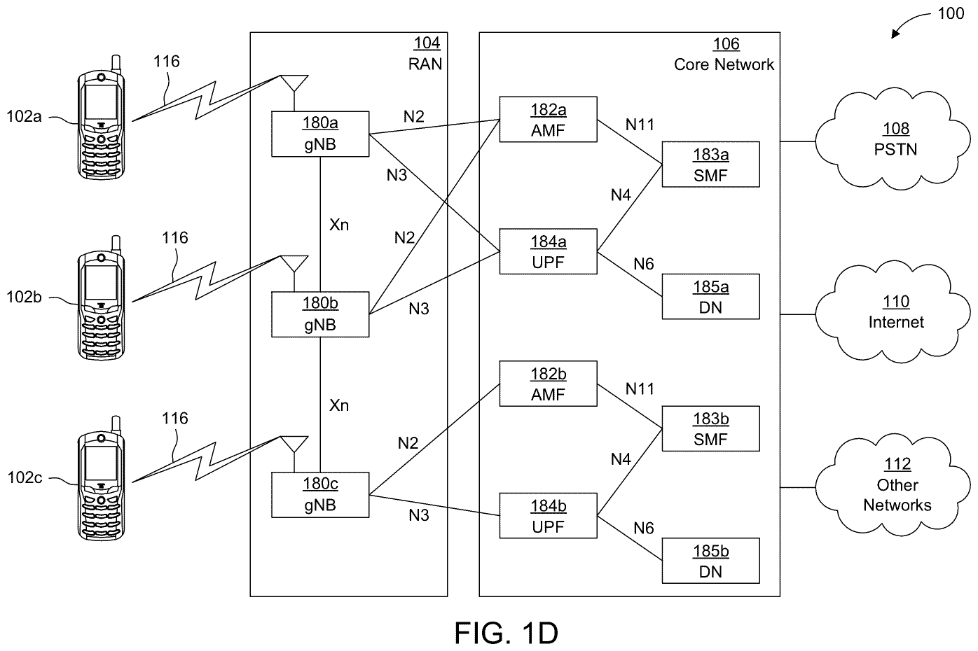

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

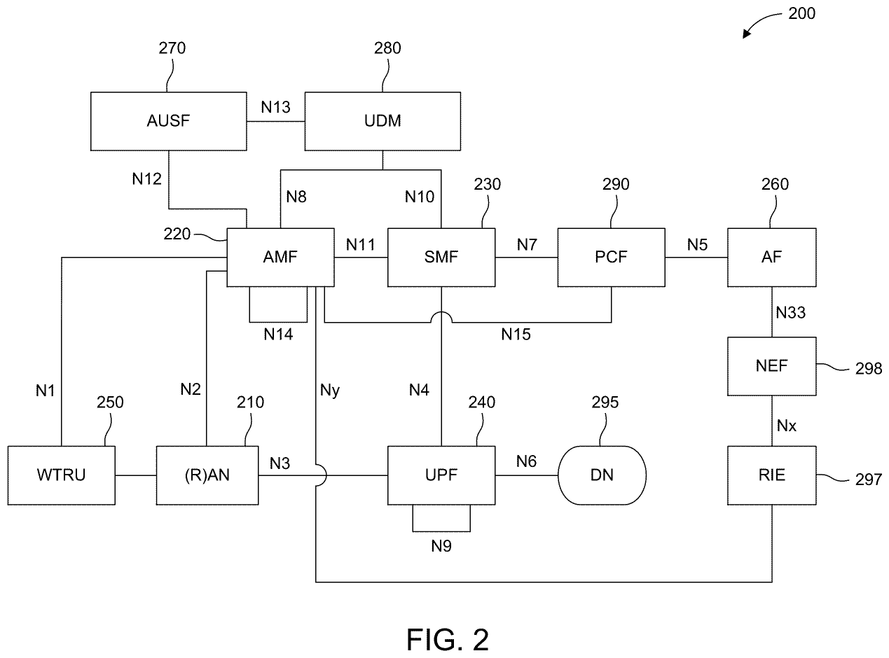

FIG. 2 illustrates is a reference model 200 of a potential architecture of 5G or NextGen network. The architecture of model 200 specifies discrete interfaces between control-plane elements. RAN 210 refers to a radio access network based on the 5G RAT or Evolved E-UTRA that connects to the NextGen core network. The Access Control and Mobility Management Function (AMF) 220 at least includes the following functionalities, Registration management, Connection management, Reachability management, Mobility Management, etc. The Session Management Function (SMF) 230 at least includes the following functionalities, session management (including session establishment, modify and release), WTRU IP address allocation, selection and control of UP function, etc. The User plane function (UPF) 240 at least includes the following functionalities, packet routing & forwarding, packet inspection, traffic usage reporting, etc.

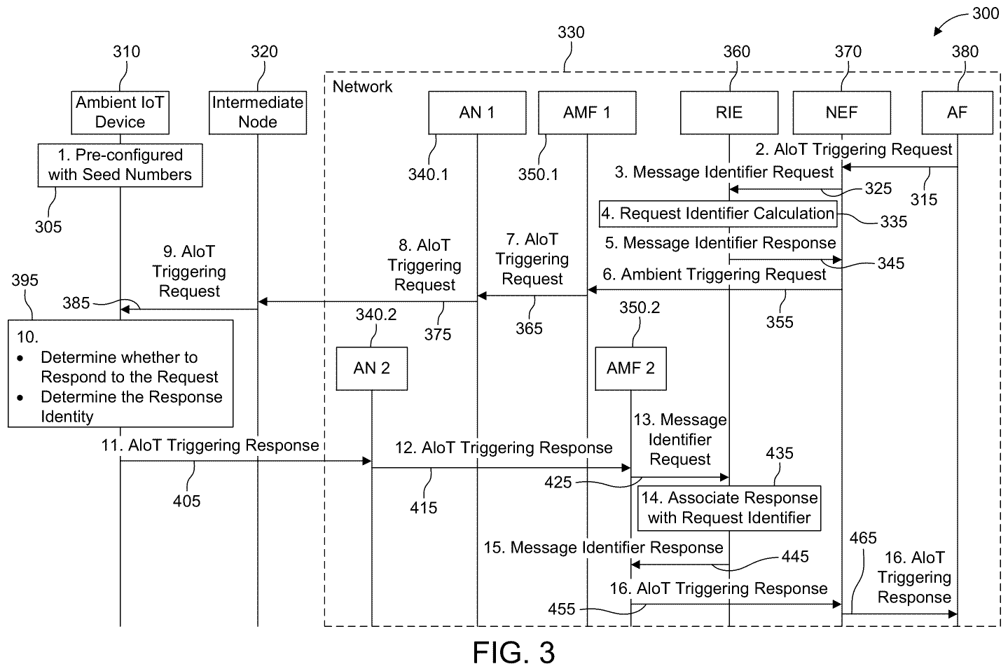

5G location service (LCS) may provide functionality to provide the positioning information of a WTRU 250. The positioning of WTRU 250 may be supported by RAT dependent position method. A RAT dependent position method may rely on, for example, 3GPP RAT measurements obtained by a target WTRU and/or on measurement obtained by an Access Network of 3GPP RAT signals transmitted by a target WTRU. Positioning of a WTRU may be supported by RAT independent position methods. A RAT independent position method may rely on non-RAT measurements obtained by a WTRU and/or on other information. Location information for one or multiple target WTRUs may be requested by and reported to an LCS client or an application function (AF) 260 within or external to a 3GPP operator network, or a control plane NF within 3GPP system. For location request from LCS client or AF 260, privacy verification of the target WTRU may be enabled to check whether it is allowed to acquire the WTRU location information. Network exposure function (NEF) 298 may be interconnected to AF 260 via connection N33. Response identification function (RIE 297) is interconnected to NEF 298 via connection Nx and interconnected to AMF 220 via connection Ny. The functions of each of RIE 297 and NEF 298 are detailed below with respect to FIG. 3. The NEF 298 authorizes trigger requests from one or more AFs 260, initiates trigger procedures, and sends trigger responses to the AFs 260. The RIE 297 generates requests identifiers and resolves response identifiers to request identifiers. The resolution operation that is performed by the RIE 297 is used by network functions to determine what AF 260 and NEF 298 should receive information that is received from a WTRU 250. The NEF 298 may receive a requests from an AF 260 and the NEF 298 may authorize the requests from the AF 260. The requests from the AF 260 may be requests to trigger one or more WTRUs 250. If a request from the AF 260 is authorized, the NEF 298 may initiate a triggering procedure. The NEF 298 may receive responses from one or more WTRUs 250 and the NEF 298 may forward the content of the responses from the WTRUs 250 to the AF 260. The NEF 298 may receive the responses from the WTRUs 250 via an AMF 220. The WTRUs 250 may be Ambient IoT Devices. The RIE 297 may receive requests from an NEF 298. The requests from the NEF 298 may be requests for a request identifier. The requests from the NEF 298 may include a sequence number. The RIE 297 may create the request identifier and store context information that is associated with the request identifier. The context information that is associated with request identifier may include the identities of the WTRUs 250 that are associated with the request identifier, the locations where the request identifier may be transmitted, the sequence number, and information related to what keys should be used by the WTRUs 250 to determine a response identifier. The RIE 297 may send a response to the NEF 298 and the response may include the request identifier. The RIE 297 may receive a second request from the AMF 220. The second request may include a response identifier. The second request may be a request for the RIE 297 to resolve the response identifier to the request identifier that is associated with the response identifier. The RIE 297 may use the response identifier and other information from the second request to determine the request identifier that is associated with the response identifier. The other information may include the location from where the response identifier was received and the identity of the device from which it was received. The RIE 297 may send a second response to the NEF 298. The second response may include the request identifier that the RIE 297 determined is associated with the response identifier to the NEF 298. The second response may include the sequence number.

Several different types of location requests may be supported. A Mobile Terminated Location Request (MT-LR) that may occur with a Mobile Terminated Location Request (MT-LR), an LCS client or AF sends a location request to the 5G Network for the location of a target WTRU. A Mobile Originated Location Request (MO-LR) that may occur with a Mobile Originated Location Request (MO-LR), a WTRU sends a request to the 5G Network for location related information for the WTRU. An Immediate Location Request that occurs with an immediate location request, an LCS client or AF 260 sends or instigates a location request for a target WTRU(s) and expects to receive a response containing location information for the target WTRU(s) within a short time period. The Immediate Location Request may be used for an MT-LR or MO-LR. A Deferred Location Request that occurs with a deferred location request, an LCS client or AF 260 sends a location request to the 5G network for a target WTRU(s) and expects to receive a response when an indicated event occurred for the target WTRU at some future time. It may be used for an MT-LR.

Authentication server function (AUSF) 270 validates the identity of a user and providing access to the network resources based on their security level.

Unified data management (UDM) 280 stores and manages the user's data, including their IMSI and authentication data. UDM 280 provides other network function, i.e., AMF 220, SMF 230, for example, with the user's data, e.g., authentication data, when requested.

Policy control function (PCF) 290 is responsible for enforcing the policies that govern the user's access to the network resources. PCF 290 provides other network function, i.e., AMF 220, SMF 230, for example, with the user's policy data when requested. Data network (DN) 295 is within the system as illustrated, and is described herein.

The inventory procedure is a procedure as that is used with Ambient IoT devices. When the AIoT device is attached to specific assets or facilities, the network might probe these devices through specific readers to obtain certain information. This information may include location, asset status, reporting data, etc. The readers may be intermediate nodes, including WTRUs, for example, and RAN nodes. Typically, the exchange in the inventory procedure has a limited amount of data that is provided in both directions.

Traffic types for Ambient IoT Devices include device-terminated (DT) and device-originated-device-terminated triggered (DO-DTT). Different connectivity topologies may be used including Topology 1 which is BS<-->Ambient IoT Device, and Topology 2 which is BS<-->intermediate node<-->Ambient IoT Device. As is understood on one WTRU may act as an intermediate node that is under the network control.

An AIoT service, which might be located in the AF, may send a request or a trigger to one or more ambient IoT devices to obtain certain information or trigger certain actions in these devices. Such ambient IoT devices may be reachable through a different number of relay devices or different routes. These relay devices may store or forward the request to the AIoT device based on the AIoT device state or current condition. For example, the relay devices may store the request if the AIoT has limited power available or in disconnect state. The AIoT device inventory response may be sent through different relay devices or routes to reach its destination. The variations in the request and response routes and number of relay devices that may be used to reach the AIoT device, in the downlink, and network, in the uplink, can lead to variability in the response delay between AIoT devices. The response delays can make associating each network request in the downlink with the AIoT device response in the uplink challenging for the network.

When a network node, which has no context stored for an ambient IoT device, receives a message from the AIoT device, there is no mechanism in the existing system for the network node to associate the uplink message with a downlink request. Associating the uplink message with a downlink request is helpful in determine what AF to send the uplink message to and it is helpful in assisting the AF to determining how to process the information in the uplink message. Given that a first network node may cause a downlink trigger message to be broadcasted, the trigger message may cause the AIoT device to transmit an uplink response message to the network, and a second network node may receive the uplink response message, it is desirable to provide a solution for the second network node to associate the uplink message with a downlink trigger. In other words, the network node that sends the trigger and the network node that receives the response may be different. A procedure is needed to enable the network node that receives the response to determine how, or where, to route the response message.

The present system, device and method provides a network function, response identification entity (RIE), to assist other network functions in associating a response with a request. When the network sends a request to the AIoT device, the network adds a request identifier to the request. The request identifier may be produced by certain functionality in the network, such as the RIE. The RIE may be a network function or a network service. When an AIoT device responds to a network request, the AIoT device may produce the response identifier. The response identifier is generated using known values and methods for both the WTRU and the network. The WTRU may be preconfigured with key values that contribute to the response identifier production or contribute to the values that can be part of the response identifier. When the network receives the response identifier, it maps the response identifier to the request identifier by extracting it. Extracting the request identifier from the response identifier may be performed using the WTRU-ID and request identifier. Extracting the request identifier from the response identifier may be performed using the preconfigured key values which can be utilized to generate values that can be used in extracting the request identifier from the response identifier by applying certain mutually agreed, between ambient IoT device and network, operations or algorithms, such as logical XOR operation, for example. After performing the mapping between the request and response identifiers, the RIE may send the ID(s) of the NF(s) or destination which the AMF may route the response to such as NEF-ID and AF-ID.

FIG. 3 illustrates an example signaling diagram depicting the network associating the AIoT devices'response(s) to the corresponding service or network request(s). The procedure demonstrates that based on the request and identifiers that are generated and communicated by the RIE, for the request identifier, and the WTRU, for the response identifier, the network can associate response(s) with corresponding network request and route the response to the correct NFs and destination. FIG. 3 illustrates the signaling 300 for linking the response to the downlink trigger call flow. At 305, AIoT 310 may receive configuration information from the network, AMF for example. The configuration information may include key values. The key values may be pre-configured in the Universal Subscriber Identity Module (USIM) or Mobile Equipment (ME), or received from network 330. In one example, the key values may be received during registration.

The keys values may be used by the AIoT 310 to produce the response identifier or produce a value that is used to generate the response identifier. The key values may be associated with certain registration areas or tracking areas in network 330 where AIoT 310 may use certain key(s) in certain location(s). RIE 360 may receive a copy of the preconfigured keys in AIoT 310 at 305.

At 315, AF 380 may send an AIoT triggering request to NEF 370. This request may originate from AF 380 where AF 380 may be requesting AIoT 310 to send certain type of information to network 330 (e.g., sensor data) or triggering AIoT 310 to send certain types of requests toward network 330 (e.g., a service request). The AIoT triggering request may have AF-ID, request sequence number, and an AIoT device ID.

At 325, upon receiving the request from AF 380, NEF 370 may send a message identifier request to RIE 360. The message identifier request may include
an identifier of AF 380 (i.e., AF-ID), an identifier of NEF 370 (i.e., NEF-ID), a request sequence number, which is a value that may be used by AF 380 to associate the response with the request, and an AIoT device ID.

At 335, upon receiving the request from NEF 370, RIE 360 may produce a request identifier by producing a request identifier calculation, for example. The IE 360 may use the request sequence number as a request identifier. In an example, RIE 360 may use the AF-ID and sequence number to produce the request identifier. For example, RIE 360 may allocate specific request identifiers to specific application functions. For example, part of the request identifier may be a value that identifies the application function.

In an example, RIE 360 may use the sequence number and key value to produce request identifier. RIE 360 may create and store the request context and associated NF(s) and destination ID(s). The request context may be associated with specific request and may contain information such as, an identifier of AF 380 (i.e., AF-ID), an identifier of NEF 370 (i.e., NEF-ID), an AIoT device ID, and a Key Set Identifier (KSI).

At 345, RIE 360 may respond to the request. The message in response to the request may include the request identifier. The message may include a Key Set Identifier (KSI). By including the KSI, AIoT 310 to decrypt the request identifier when the request needs to be encrypted by RIE 360. RIE 360 may use the KSI to locate certain keys, which are stored in AIoT 310, such as, Cipher Key (CK) and Integrity Key (IK), to encrypt the request identifier.

For example, if the request is sent between relay devices unencrypted, RIE 360 may utilize certain key(s), which are located in AIoT 310 using the KSI, to encrypt the request identifier. In other words, the connections between relay devices and between relay devices and AIoT 310 maybe unencrypted. RIE 360 may encrypt the request identifier so that relays and network nodes in the path between RIE 360 and AIoT 310 are unable to obtain significant information from the request identifier. The message may include a routing indicator to allow AMF 350.1 to forward the message to targeted RIE 360. The routing indicator may be used by AMF 350.1 to determine which RIE 360 to route the message to. The routing indicator may be an RIE-ID. The request identifier may be the routing indicator.

At 355, upon receiving the response from RIE 360, NEF 370 may send an AIoT request message to AMF 350.1. The message may include targeted AIoT device(s) ID(s), the request identifier, the ID of AF 380, which has requested the action, the routing indicator, and the key set identifier (KSI).

At 365, upon receiving the request from NEF 370, AMF 350.1 may send the received request to the corresponding AN 340.1 which serves AIoT 310.

At 375, upon receiving the message from AMF 350.1, AN 340.1 may broadcast the request message to the WTRUs that are in range of the AN 340.1. In other words the AN may broadcast the request message and the request message may be received by the WTRUs that are within range of the signal that is transmitted by the AN 340.1. The message may target AIoT 310, AF-ID, request identifier, routing indicator and KSI.

At 385, one or more AIoT 310 may receive the broadcast message from AN 340.1. Based on the range of AIoT 310 that is received in the broadcasted message by AN 340.1, AIoT 310 may determine whether to respond to or ignore the request. In the multi relay devices scenario, AIoT 310 may act as a relay device and the relay device(s) may receive, process or forward the message to the targeted AIoT 310 or to the next relay device, subject to the agreement between the different relay devices and AIoT 310.

At 395, when AIoT 310 receives the broadcasted request, AIoT 310 may check the AIoT device(s) ID(s) in the request and decide whether to respond to or ignore the request. If AIoT 310 decides to respond to the network request, an AIoT triggering response message may be sent to network 330 by AIoT 310. If the request identifier is encrypted, AIoT 310 may use the KSI to locate certain keys, which may be stored in AIoT 310 such as, Cipher Key (CK) and Integrity Key (IK), to decrypt the request identifier. The AIoT triggering response message may include response content, a response identifier, AIoT device location information, a routing indicator, an AIoT message indicator, which indicates that the message is an AIoT device message, and an ambient IoT device ID.

The response identifier may be the same as the request identifier, and a combination of AIoT 310 ID and request identifier or a result of calculations using both values (AIoT device ID and request identifier). The response identifier may be a combination of the request identifier and locally generated key based on the provided key values in the configuration information at 305. AIoT 310 and network 330 NF, RIE 360, for example, may be able to generate the same key. The generation of this key may be performed using simple to compute but difficult to reverse functionality or algorithms (e.g., cryptographic-grade one-way function, with specific properties, such as collision resistance). For example: the key value may be calculated using a hash function and then XOR using the request identifier. The result may be sent as response identifier.

At 405, the AIoT triggering response message may be sent to AN 340.2. The response may include response content, a response identifier, AIoT 310 location information, AIoT message indicator, and AIoT 310 ID. AIoT 310 may encrypt the response identifier using KSI in case the traffic is sent unencrypted between AIoT device 310 and relay device or AN 340.2, for example.

The recipient AN 340.2 may be different than AN 340.1 that has broadcasted the request due to AIoT 310 or relay device mobility, for example. In a scenario where relay devices are being used to send the uplink data, AIoT 310 may send an AIoT triggering response to a relay device. The relay device may forward the response to AN 340.2 or another relay device.

At 415, when receiving the response from AIoT 310, AN 340.2 may forward the response to AMF 350.2. The recipient AMF 350.2 may not be the same as the requesting AMF 350.1. In this example, AN2 340.2 is connected to a different AMF 350.2 than AMF 350.1 in the downlink. When AMF 350.2 receives the response message, AMF 350.2 may check the content of the message to be able to forward the message.

At 425, when receiving the message from AMF 350.2, AMF 350.2 may check the content of the message to be able to forward the message. If AMF 350.2 determines that the message has an AIoT message indicator and the message is sent by AIoT 310, AMF 350.2 may check if the message has a routing indicator to route the message to the targeted RIE 360. When AMF 350.2 determines RIE 360, using the routing indicator, AMF 350.2 may send a message identifier request to RIE 360. The message may include The response identifier, AIoT Device(s) ID(s), and ambient IoT device location information.

At 435, RIE 360 may receive a message identifier request from AMF 350.2 and associate the response identifier with the request identifier. RIE 360 may associate the response with the request using locally generated key(s) which are, or may be, the same as the keys generated in AIoT 310 using the key values which are part of the configuration information at 305. RIE 360 may use same key value(s), which are preconfigured in AIoT 310, and the same algorithm to generate key(s) that utilize in matching the response with the request. RIE 360 may use AIoT 310 location to select the corresponding key value that used to generate the key(s). The key(s) may be used to extract certain information from the response identifier, such as a request identifier, which enables RIE 360 to associate the request with the response and instruct AMF 350.1 to forward the message to a specific NEF 370 and destination, such as AF 380.

### RIE 360 may receive a copy of the preconfigured keys in AIoT 310 at 305.

RIE 360 may decrypt the response identifier if encrypted by AIoT 310 using KSI. RIE 360 may try stored KSI(s) for certain AIoT 310 in RIE 360, to decrypt the request, in case AIoT 310 has multiple requests contexts stored in RIE 360. The KSI may be sent to RIE 360 in the response message from AIoT 310.

AIoT 310 may use the location of AIoT 310 or the identity of AN 340.2 that AIoT 310 received the encrypted request identifier from to determine which key from the set to use the decrypt the encrypted request identifier.

At 445, RIE 360 may send a message identifier response to AMF 350.2. The message may include request context information, such as the identifier of NF(s) that AMF 350.2 has to forward AIoT 310 response to, e.g., the NEF-ID and AF-ID and request sequence number.

At 455, AMF 350.2 sends an AIoT triggering response message to NEF 370. The message may include AIoT Device(s)-ID(s), response content, AF-ID and request sequence number.

At 465, using the received AF-ID, NEF 370 may forward the response to AF 380.

As set forth in FIG. 3, RIE 360 may function to linking uplink responses to downlink triggers. In 325 of FIG. 3, RIE 360 may receive a request message. The purpose of the request message may be to trigger RIE 360 to create a request identifier and to store context for the request identifier. The request message may include an identifier of AF 380, for example. RIE 360 may use AF 380 to determine the request identifier. For example, RIE 360 may create the request identifier such that it contains the AF ID or a value that represents AF 380 or AF ID. For example, RIE 360 may associate certain request identifiers with AF 380. In other words, RIE 360 may have a pool of request identifiers that are associated with AF 380. RIE 360 may store the AF ID in the request identifier context so that RIE 360 can determine where any associated response should be sent.

The request message may include an identifier of NEF 370. RIE 370 may store the NEF ID in the request identifier context so that RIE 360 can determine where any associated response should be sent.

The request message may include an AIoT Device ID. RIE 360 may use the AIoT Device ID to determine the request identifier. For example, RIE 360 may create the request identifier such that it contains the AIoT Device ID or a value that represents AIoT 310 or AIoT Device ID. For example, RIE 360 may associate certain request identifiers with the AIoT Device ID. In other words, RIE 360 may have a pool of request identifiers that are associated with AIoT 310.

The request message may include location information. The location information may identify the location(s) where the message may be broadcasted. The location information may be a list of cell identifiers, a list of reader identifiers, a geographical area, or a list of tracking areas. RIE 360 may use the location information to determine the request identifier. For example, RIE 360 may create the request identifier such that it contains the location information or a value that represents the location information or location. For example, RIE 360 may only associate certain request identifiers with the location. In other words, RIE 360 may have a pool of request identifiers that are associated with the location.

The request message may include a request sequence number. RIE 360 may store the request sequence number in the request identifier context so that, the request sequence may be used by AF 380 to an associated a future response with the request.

RIE 360 may produce an encrypted request identifier. RIE 360 may have access to keys that are associated with each AIoT Device 310. The keys that are associated with each AIoT 310 may be stored in RIE 360, or the keys may be stored in a UDR, and RIE 360 may be able to receive the keys from the UDR. Each AIoT 310 may be associated with a set of keys. The key in the set of keys that is used may be location dependent. In other words, AIoT 310 may be expected to use a first set of keys when communicating via a first reader or base station and AIoT 310 may be expected to use a second set of keys when communicating via a second reader or base station. RIE 360 may use the AIoT Device ID and location information to determine a key and then use the key to create an encrypted request identifier. The key that RIE 360 uses to create the encrypted request identifier may be identified by a key set identifier (KSI). RIE 360 may store the encrypted request identifier and request identifier in the request identifier context. RIE 360 may store the KSI in the request identifier context.

Encrypting the request identifier may be advantageous because information about the requestor, information about the intended recipient of the request, and information about the content of the request may be part of the request identifier. Furthermore, some network nodes (e.g., intermediate nodes 320 or relays) may forward the request identifier towards AIoT 310, and it may not be desirable to expose information from the request identifier to the network nodes.

In 345 of FIG. 3, RIE 360 may send a response message. The purpose of the response message may be to provide NEF 370 with the encrypted request identifier.

At 355, 365, 375, and 385 in FIG. 3, the encrypted request identifier may be sent through network nodes such as AMF 350, AN 340 (e.g., a base station and reader), and intermediate nodes 320. AN 340 and readers may broadcast the encrypted request identifier. The encrypted request identifier may be forwarded to AN 340 that are associated with the location information that was provided to RIE 360, for example.

In 395 of FIG. 3, AIoT 310 may receive the encrypted request identifier and attempt to decrypt the encrypted request identifier. AIoT 310 may be configured with multiple sets of keys. AIoT 310 may determine which key of the set of keys to use to decrypt the encrypted request identifier. AIoT 310 may use the location of AIoT 310 or the identity of the AN 340 that AIoT 310 received the encrypted request identifier from to determine which key from the set to use to decrypt the encrypted request identifier.

After AIoT 310 performs the decryption operation, AIoT 310 may determine that the decrypted request identifier is not properly formatted or not addressed to AIoT 310. AIoT 310 may determine that AIoT 310 should not send a response message. After AIoT 310 performs the decryption operation, AIoT 310 may determine that the decrypted request identifier is properly formatted and is addressed to AIoT 310. AIoT 310 may determine that AIoT 310 should send a response message. AIoT 310 may use the request identifier to determine what application layer data (e.g., an Application Payload) to send in the response message.

AIoT 310 may determine a response identifier. The response identifier may be set to a value that is equal to all or part of the request identifier. Being equal to part of the request identifier means that the value is equal to only certain fields of the request identifier, for example. AIoT 310 may determine an encrypted response identifier. The encrypted response identifier may be determined based on the performing an encryption operation that uses the response identifier and the determined key (i.e., the location, or reader, dependent key).

AIoT 310 may determine a routing indicator. The routing indicator may be determined based on the request identifier. For example, the routing indicator may be part of the request identifier. The routing indicator may be used by network nodes to determine which RIE 360 NF instance to use to forward a response.

In 405 of the procedure of FIG. 3, AIoT 310 may send a response message. AIoT 310 may include the application payload, the encrypted response identifier, a routing indicator, and an AIoT Device ID.

At 415 and 425 in FIG. 3, network nodes may receive the response message form AIoT 310 and forward the information from the response message to RIE 360. The network nodes may use the routing indicator to determine which RIE 360 to forward the information form the response message.

At 435 in FIG. 3, the network nodes may receive the response message. RIE 360 may receive the identity of AN 340 that received the response message. For example, RIE 360 may receive the identity of reader, base station, relay or intermediate node 320 that received the response from AIoT 310. RIE 360 may use the identity of the reader, base station, relay or intermediate node 320 to determine the location from where the response was received. RIE 360 may use the determined location information and the received AIoT Device ID to determine a key from the AIoT 310 key set to use to decrypt the encrypted response identifier. RIE 360 may use the key to perform a decryption operation on the encrypted response identifier. The result of the operation may be a response identifier or a value that may be mapped to the request identifier. RIE 310 may use the key to perform a decryption operation on the application payload. The result of the operation may be a decrypted application payload. RIE 360 may use the request identifier to obtain a request sequence number, an AF ID and NEF ID that is stored in the context information that is associated with the request identifier.

At 445 in FIG. 3, RIE 360 may send a response message including a message identifier. For example, the response message may include the Request Sequence Number, AF ID, NEF ID, Decrypted Application Payload, and Location Information.

An alternative to using the AIoT Device ID in the procedure of FIG. 3 is to use an AIoT Group ID. The AIoT Group ID may be associated with a group of AIoT 310 and each AIoT 310 in the group may be associated with a comment key when in certain locations.

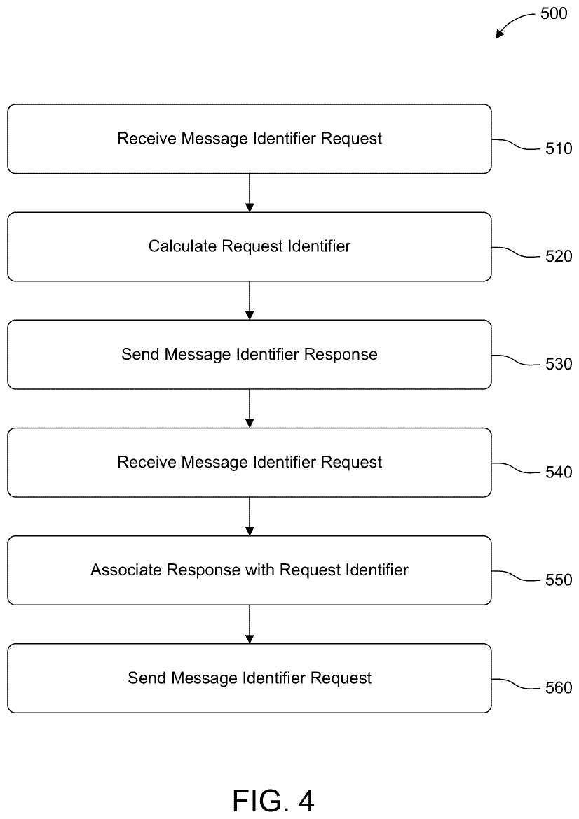

FIG. 4 illustrates a method 500 performed in RIE 360. Method 500 includes RIE 360 receiving a message identifier request at 510. As described in the signaling diagram 300, RIE 360 may receive a message identifier request at 325. RIE 360 receives a request message to trigger the creation of a request identifier. The request message includes an NF identifier or AF identifier, for example. The request message may include a request sequence number. The NF identifier may be a NEF ID.

Method 500 includes RIE 360 calculating a request identifier at 520. As described in the signaling diagram 300, RIE 360 may request an identifier calculation at 335. RIE 360 calculates and assigns a request identifier and stores context information. The request identifier may include a routing indicator. The request identifier may be the request sequence number. RIE 360 may use the AF-ID and sequence number to produce the request identifier. The context information includes the request identifier, the NF identifier or AF identifier. The context information includes a request sequence number. The routing indicator identifies the RIE NF. The RIE NF may assign a key set indicator and stores the key set indicator in the context information.

Method 500 includes RIE 360 sending a message identifier response at 530. As described in the signaling diagram 300, RIE 360 may provide a message identifier response at 345. RIE 360 sends a response message. The response message includes the request identifier. The response message may include the key set identifier.

Method 500 includes RIE 360 receiving a message identifier request at 540. As described in the signaling diagram 300, RIE 360 may receive a message identifier request at 425. RIE 360 receives a response identifier resolution request message. The response identifier resolution request message includes a response identifier. The response identifier resolution request message may include the identity of an AIoT 310. The response identifier resolution request message may include information about the location from where the response identifier was received.

Method 500 includes RIE 360 associating a response with the request identifier at 550. As described in the signaling diagram 300, RIE 360 may associate a response with the request identifier at 435. RIE 360 based on the stored context and the information from the response identifier resolution request message, determines that the response identifier is associated with the request identifier.

Method 500 includes RIE 360 sending a message identifier response at 560. As described in the signaling diagram 300, RIE 360 may send a message identifier response at 445. RIE 360 sends a response identifier resolution response message. The response identifier resolution response message includes the NF identifier or AF identifier.

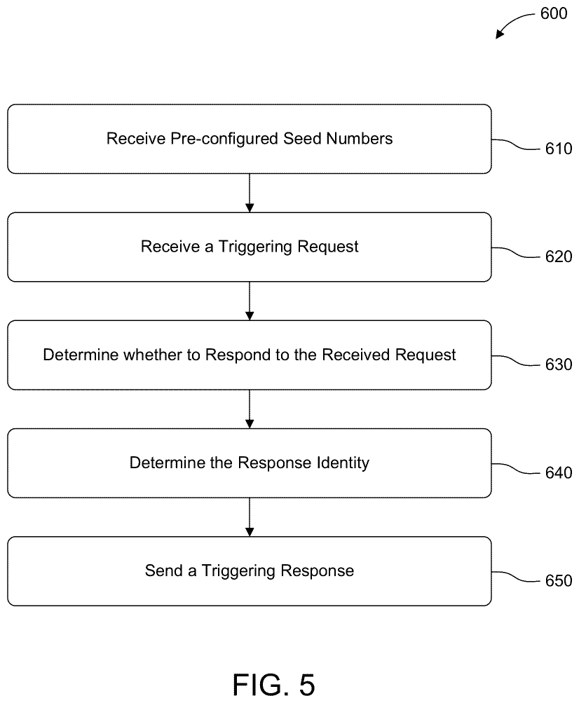

FIG. 5 illustrates a method 600 performed in AIoT 310. Method 600 includes AIoT 310 receiving a pre-configured seed numbers at 610. As described in the signaling diagram 300, AIoT 310 may receive or be pre-configured with seed numbers at 305. Configuration information is received by AIoT 310, either pre-configured in the USIM or pre-configured in memory of AIoT 310 or configured in AIoT 310 in some other fashion. This may include being sent to AIoT 310 by AMF 350. The configuration information includes credentials that can be used to generate response identifier. The configuration information may include keys and values which can be used by AIoT 310 to generate values which contribute to the response identifier generation.

In a configuration where the configuration information is sent to AIoT 310 by AMF 350, AIoT 310 receives a pre-configuration request from AMF 350. The pre-configuration request may include the configuration information. AIoT 310 sends a pre-configuration response to AMF 350. The pre-configuration response may indicate that the configuration is complete (i.e., successful).

Method 600 includes AIoT 310 receiving a triggering request at 620. As described in the signaling diagram 300, AIoT 310 may receive a triggering request at 385. AIoT 310 receives a request message from network 330. The request message may include a target identifier (e.g. AIoT device ID(s)) and a request identifier. The target identifier identifies one or more AIoT devices 310. AIoT 310 may determine that the target identifier identifies AIoT 310. For example, the target identifier is an identifier of AIoT 310 or identifies a group that AIoT 310 belongs to. The request message may include a KSI.

Method 600 includes AIoT 310 determining whether to respond to the received request at 630. As described in the signaling diagram 300, AIoT 310 may determine whether to respond to the received request at 395. AIoT 310 determines a response identifier. The response identifier is determined based on the request identifier and at least one value that was configured in AIoT 310 before receiving the request message or at least one value that was generated using the configured values in AIoT 310. The response identifier may be calculated using the request identifier and AIoT device ID. The response identifier may be determined, or calculated, using a generated key, which is generated using the preconfigured keys in AIoT 310, and other parameters such as request identifier. AIoT 310 may encrypt the response identifier using KSI.

Method 600 includes AIoT 310 determining the response identifier at 640. As described in the signaling diagram 300, AIoT 310 may determine the response identifier, which can be used by the network to match the response from the WTRU with the request that was broadcasted by the AN, at 395.

Method 600 includes AIoT 310 sending a triggering response at 650. As described in the signaling diagram 300, AIoT 310 may send a triggering response at 405. AIoT 310 sends a response message to the network. The response message may include the response identifier.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a network node, the method comprising:
receiving, from a network entity, a request for a message identifier to trigger generation of a request identifier, wherein the request for a message identifier includes a sequence number and at least one of a network function (NF) identifier or an application function (AF) identifier;
generating the request identifier;
sending, to the network entity, a first identifier response including the request identifier;
receiving, from the network entity, a second request for the message identifier including a response identifier of the second request;
determining that the response identifier of the received second request is associated with the request identifier; and
sending, to the network entity, a message identifier response, wherein the message identifier response includes the sequence number and at least one of the NF identifier or the AF identifier.

2. The method of claim 1, wherein the second request for the message identifier includes an identity of an ambient-power enabled internet of things (AIoT) device and information about a location from where the response identifier of the second request was received.

3. The method of claim 1, wherein the network node comprises a response identification entity.

4. The method of claim 1, wherein the NF identifier is a network exposure function (NEF) identifier.

5. The method of claim 1, wherein the request identifier includes a routing indicator.

6. The method of claim 1, further comprising context information associated with the request identifier, wherein the context information includes the at least one of an NF identifier or an AF identifier and the sequence number.

7. The method of claim 1, wherein the first identifier response includes a key set identifier.

8. The method of claim 1, wherein the second request for the message identifier includes the identity of an AIoT device.

9. The method of claim 1, wherein the second request for the message identifier includes information about a location from where the response identifier of the second request was received.

10. A method performed in a wireless transmit receive unit (WTRU) comprising:
receiving a configuration information;
receiving a triggering request including a target identifier and a request identifier;
determining whether to respond to the received request based on determining that the target identifier identifies the WTRU or identifies a group of WTRUs that the WTRU is associated with;
determining a response identifier; and
sending a response message, wherein the response message includes the response identifier.

11. The method of claim 10, wherein the WTRU comprises an ambient-power enabled internet of things (AIoT) device.

12. The method of claim 10, wherein the configuration information is pre-configured in an universal subscriber identity module (USIM).

13. The method of claim 10, wherein the configuration information is pre-configured in memory of the WTRU.

14. The method of claim 10, wherein the configuration information is sent to the WTRU by a network node.

15. The method of claim 14, wherein the network node is an access and mobility management function (AMF).

16. The method of claim 10, wherein the configuration information includes credentials used to generate the response identifier.

17. The method of claim 10, wherein the configuration information includes keys and values to generate the response identifier and wherein the keys are associated with a key set identifier (KSI) value.

18. The method of claim 10 wherein the target identifier identifies the WTRU.

19. The method of claim 10, wherein the response identifier is determined based on the request identifier and at least one value that was configured in the WTRU.

20. The method of claim 10, wherein a response message is sent to a network node.
